(19) United States
(12) Patent Application Publication
(10) Pub. No.: US 2020/0193369 A1
(43) Pub. Date: Jun. 18, 2020

(54) SYSTEM AND METHOD FOR MANAGING SHIPPING PROCESSES AND PERSONNEL

(71) Applicants: Elisbel Soler Negrin, Miami, FL (US); Edisley Soler Negrin, Miami, FL (US)

(72) Inventors: Elisbel Soler Negrin, Miami, FL (US); Edisley Soler Negrin, Miami, FL (US)

(21) Appl. No.: 16/682,092

(22) Filed: Nov. 13, 2019

Related U.S. Application Data
(60) Provisional application No. 62/779,162, filed on Dec. 13, 2018.

(51) Int. Cl. G06Q 10/08; G06Q 10/06; G06Q 50/30

(52) U.S. Cl. CPC G06Q 10/0833; G06Q 50/30; G06Q 10/06311; G06Q 10/08355

(57) ABSTRACT

A system for monitoring shipping processes and personnel, comprising a plurality of vehicles each associated with a driver to permit the driver to access an application to request and store data for one or more shipments. A plurality of warehouses in communication with the application to request shipment of a plurality of goods. The shipment request is transmitted to the plurality of drivers. A database stores a plurality of data including driver information, warehouse information, and information for the one or more shipments. A camera is in operable communication with the computing device, the camera operable to collect a plurality of images and transmit the plurality of images to a processor to interpret the plurality of images via an interpreter and input the information to a document. The document is stored in a database and transmitted via the computing device to a second computing device operated by an administrative user.

### CROSS-REFERENCE TO RELATED APPLICATIONS

The present application claims priority to U.S. Provisional Application No. 62/779,162, filed on Dec. 13, 2018, entitled “SYSTEM AND METHOD FOR MONITORING SHIPPING PROCESSES AND PERSONNEL” the entire disclosure of which is incorporated by reference herein.

### TECHNICAL FIELD

The embodiments presented relate to a system for monitoring shipping processes and personnel.

### BACKGROUND

The shipping industry consists primarily of three types of carriers. Small package carriers, such as Federal Express, pick up small packages and consolidate these small packages into larger loads, which are shipped near their destination point before final delivery. In contrast, truckload carriers are larger customers who can fill entire trucks or containers. Between these two types are less-than-load (LTL) carriers who pick up freight from various customers throughout the day. The freight is brought to a warehouse and sorted, often by destination, and reloaded onto delivery trucks. Each shipment is governed by a separate contract, known as a “bill of lading.” Each customer may utilize their own specific bill of lading form, which they use for shipping assets, causing inefficiencies and inaccuracies throughout the process.

Once a successful shipment is ordered as well as when the shipment is completed, the driver must wait in line to process the many bill of lading forms accumulated throughout the day. Each document is often manually processed by administrative personnel.

The logistics industry has used a variety of vehicle and personnel tracking techniques to monitor assets throughout the shipping process. Cargo theft, whether intentional or inadvertent, has become increasingly prevalent as few entities can detect fraudulent authorization papers. Much of the problem originates from the manual input of data throughout the shipping process.

### SUMMARY OF THE INVENTION

The embodiments disclose a system for monitoring shipping processes and personnel, comprising a plurality of vehicles each associated with a driver to permit the driver to access an application to request and store data for one or more shipments. A plurality of warehouses in communication with the application to request shipment of a plurality of goods. The shipment request is transmitted to the plurality of drivers. A database stores a plurality of data including driver information, warehouse information, and information for the one or more shipments. A camera is in operable communication with the computing device, the camera operable to collect a plurality of images and transmit the plurality of images to a processor to interpret the plurality of images via an interpreter and input the information to a document. The document is stored in a database and transmitted via the computing device to a second computing device operated by an administrative user.

The embodiments provide an efficient and time-saving check-in process for drivers who are contracted to ship a load from one location to the other. The system provides an electronic means for tracking various shipping processes and securely storing shipping documents for easy retrieval, review, and interpretation.

In one aspect, the information includes the following: load information, shipping information, a bill of lading, driver information, vehicle information, and trailer information.

In another aspect, the system includes auxiliary personnel in communication with a scheduler. The auxiliary personnel can include lumpers, wherein the lumpers are scheduled via the scheduler to unload freight.

In one aspect, one or more third-party users are in operable communication with the database.

In one aspect, the computing device is in operable communication with an application server in operable communication with a plurality of modules. The plurality of modules can include a scanning and imaging module, an interpreter, a scheduler, a logistics module, a comparator, and a communications module.

In one aspect, the application server is in operable communication with a processor configured to receive, via the camera, an image and then scan the image. The image is transmitted to the interpreter, and the information contained therein is parsed into the shipping document. The document is then transmitted to the appropriate users within the system.

### BRIEF DESCRIPTION OF THE DRAWINGS

A complete understanding of the present invention and the advantages and features thereof will be more readily understood by reference to the following detailed description when considered in conjunction with the accompanying drawings wherein:

FIG. 1 illustrates a block diagram of the network infrastructure for the system for monitoring shipping processes and personnel, according to some embodiments;

FIG. 2 illustrates a block diagram of the application server and modules, according to some embodiments;

FIG. 3 illustrates a block diagram of the network infrastructure, according to some embodiments;

FIG. 4 illustrates a flowchart for a method for managing shipping information and personnel, according to some embodiments;

FIG. 5 illustrates a screenshot of a user interface for the driver, according to some embodiments;

FIG. 6 illustrates a screenshot of a user interface for the broker, according to some embodiments;

FIG. 7 illustrates a screenshot of a dispatcher interface, according to some embodiments;

FIG. 8 illustrates a screenshot of a warehouse user interface, according to some embodiments;

FIG. 9 illustrates a screenshot of a user interface for the lumper(s), according to some embodiments;

FIG. 10 illustrates a screenshot of a user interface for the DOT administrator, according to some embodiments; and

FIG. 11 illustrates a block diagram of the network of users according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing the exemplary embodiments in detail, it is noted that the embodiments reside primarily in combinations of components related to the system and method. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The embodiments provide for a network-integrated application that dynamically and bi-directionally communicates with transportation vehicles and personnel in addition to remotely processing transportation documentation. The system can be used by various forms of asset management to increase the accuracy and efficiency of the shipping process by ensuring that freight is quickly released to the correct driver. As used herein, the term “primary user” can include drivers or other operators throughout the shipping process.

The embodiments provide an efficient and time-saving check-in process for drivers who are contracted to ship a load from one location to the other. The system provides an electronic means for tracking various shipping processes and securely storing shipping documents for easy retrieval, review, and interpretation.

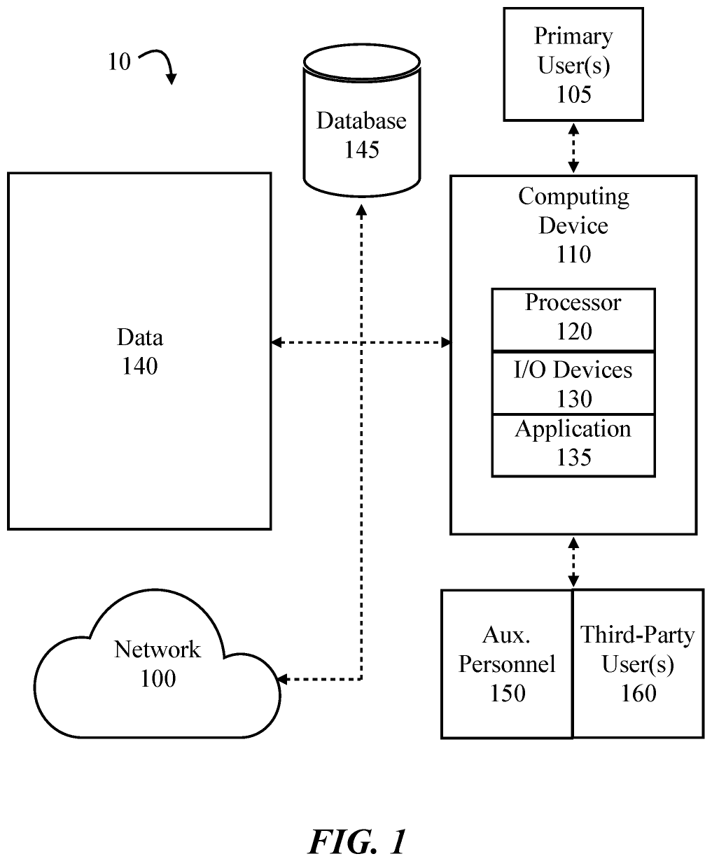

FIG. 1 shows a block diagram of the system 10. A computing device 110 operated by a primary user(s) 105, auxiliary personnel 150, or third-party users 160 is in wireless communication with a database 145 via network 100. Network server sends and receives data stored to and from a database 145. The network 100 may be the Internet, a cellular network, a wired network, a wireless network, a cloud computing network, or other conventional network technology recognized in the art. It should be understood that, in practice, there will be plural and likely a large number of computing devices 110 connected to the network 100. The network server may be a unitary device but would preferably be implemented as a server farm or a distributed computing system to handle large capacities of data 140 in the database 145 and the many simultaneous connections with computing devices 110. Further examples of communication networks include a local area network (“LAN”), a wide area network (“WAN”), an inter-network (e.g., the Internet), and peer-to-peer networks (e.g., ad hoc peer-to-peer networks).

In some embodiments, the system 10 is world-wide-web (www) based, and the network server is a web server delivering HTML, XML, etc., web pages to the computing device 110, to the auxiliary personnel 150, and third-party users 160 and their associated computing devices 110. In other embodiments, a client-server architecture may be implemented in which the network server executes enterprise and custom software, exchanging data with custom client applications running on the computing device 110.

Each computing device includes a processor 120 operable to perform instructions provided by an application 135. Processors 120 suitable for the execution of a computer application program include both general and special purpose microprocessors and any one or more processors of any digital computing device. The processor 120 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive). Memory devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

In some embodiments, a computing device 110 includes the processor 120. An application 135 program is encoded to carry out the system 10. The computing device 110 can also be used with user interface hardware, including input/output devices 130. The user interface hardware is, for example, a camera, a pointing device, a keyboard, a touchscreen, or similar implements which are employed to input data to the processor 120, or a display that visually provides data to a user. A specific example of the computing device 110 is a portable personal computer, a smartphone, or a tablet.

The database 145 may include a computer-readable medium storing the data 140 and/or the application 135 may be configured to be stored in the cloud. The information can include primary user 105, auxiliary personnel 150, and third-party user 160 credentials, personal information, licensing data, scheduling data, and other useful metrics and data known in the arts of shipping, asset management, and logistics. The data 140 may also include documents, such as a bill of lading or similar contracts. Further, the data 140 can include payment processing information for any party using the system.

In some embodiments, data 140 may be tagged with an identifier prior to storage within the database 145. For example, a complete bill of lading may be tagged as such to facilitate future recollection.

In some embodiments, auxiliary personnel 150 can include any person involved in the process as described herein. In one example, auxiliary personnel include lumpers who may be contracted to aid in the loading and/or unloading of cargo at the origin and destination facilities.

In some embodiments, third-parties are in communication with the network 100. The third-parties can include government agencies, law enforcement, security agencies, and similar groups involved in asset management, shipping of goods, and logistics and the fidelity thereof In one example, the third-party is a law enforcement agency which is given access to inquire the system 10 for various information as described hereinabove. For instance, the third-party can inquire for information contained in the bill of lading, such as the shipper, consignee, and the origin and destination of the freight. This aids in process transparency by facilitating the enforcement of on-road inspection processes. Access by the third-parties may be mandatory or optional depending on applicable laws and regulations governing the transportation of freight.

In some embodiments, automated check calls may be generated to various personnel involved in a shipment once the check-in process is underway.

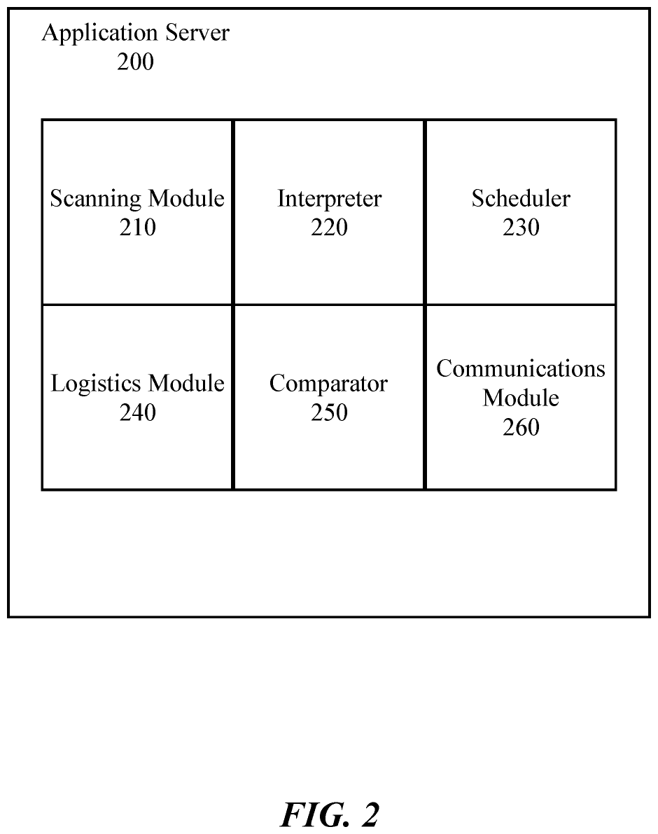

FIG. 2 illustrates a block diagram of the application server 200 in operable communication with various systems of the application. In some embodiments, a scanning and imaging module 210 may be in operable communication with an imaging device. The scanning and imaging module 210 receives an image from the camera of the computing device and transmits the image to an interpreter 220. The interpreter 220 may utilize optical recognition to interpret contents of the image such as the driver identity, vehicle and trailer information and identifiers, freight information, or shipping information contained in various shipping documents. A scheduler 230 may facilitate the scheduling of shipping services. The scheduler 230 is in communication with a logistics module 240 to determine optimal scheduling dependent on driver and vehicle availability, and locations of the same. A comparator 250 may be utilized to compare images provided by the scanning and imaging module 210 to reference images stored in the database. A communications module 260 provides a communication interface between users in the system.

In some embodiments, the interpreter 220 determines the information contained in the image and parses the information into input fields contained in a document, such as the bill of lading. This process is performed automatically to reduce the time drivers spend checking in throughout the shipping process.

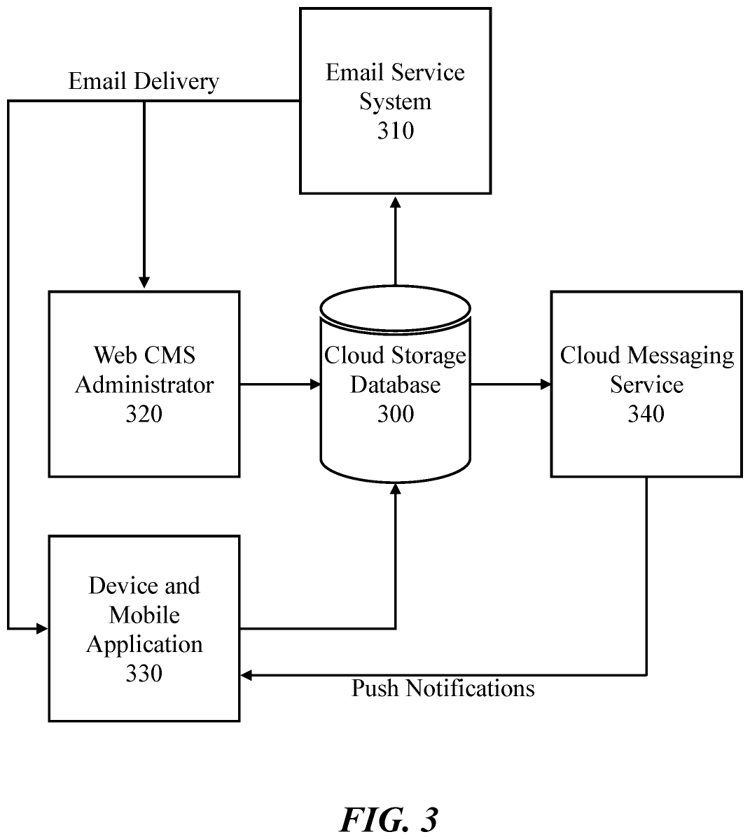

FIG. 3 illustrates a network infrastructure for the system in an exemplary embodiment. A cloud storage database 300 is in operable communication with an email service system 310 via an SMTP connection or similar connection means. A web CMS administrator 320 is in operable communication with the cloud storage database 300 which receives the email deliveries from the email service system 310. A device having the mobile application 330 is in operable communication with the cloud storage database 300 and may also receive emails from the email service system 310. A cloud messaging service 340 is in operable communication with the cloud storage database 300 and transmits push notifications to the device having the mobile application 330.

In some embodiments, the device having the mobile application is in operable communication with the cloud storage database using geo-fencing, such that the device and mobile application are only in operable communication with the cloud storage database while in predefined locations determined by the geo-fence.

In some embodiments, an application programming interface (API) connection provides the mobile application and the web CMS administrator.

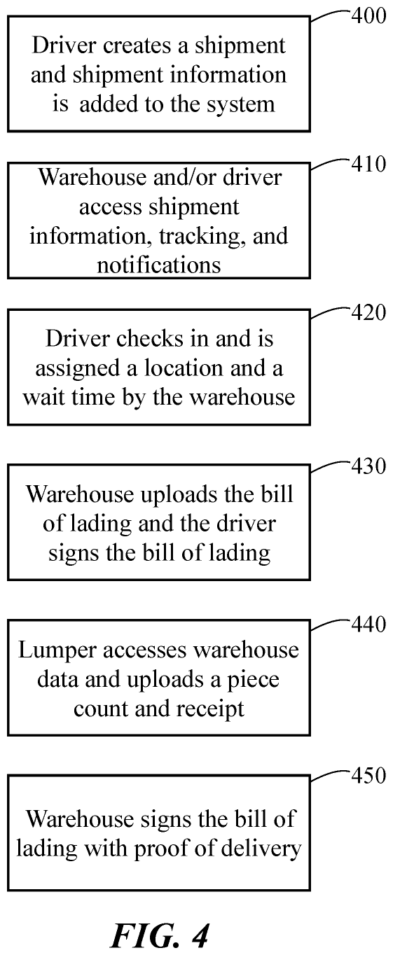

FIG. 4 illustrates a method for managing shipping processes and personnel. In step 400, the driver creates a shipment by adding various details related to the shipment. The shipping details are transmitted to the database. The carrier and/or the driver are able to access the shipment details, shipment tracking, and notifications in step 410. In step 420, the driver electronically checks in to the warehouse and is assigned a location and wait time by the warehouse. In step 430, the warehouse uploads the bill of lading, and the truck driver signs the bill of lading. In step 440, the lumper(s) access the warehouse database and upload a piece count and receipt for services rendered. In step 450, the warehouse signs the bill of lading with proof of delivery of the shipment.

In some embodiments, the user creates a user account using the application by first logging on to the system using unique login credentials (e.g., usernames, passwords, emails, etc.) created by the user, or created by the system and provided to the user. The user selects an account type, such as a “broker account”, “carrier account” or a “lumper account”. For carrier accounts (i.e., a driver or shipping company), the user adds their DOT number and MC number to their account profile along with their login credentials. Each account type may require different login credentials depending on the user type.

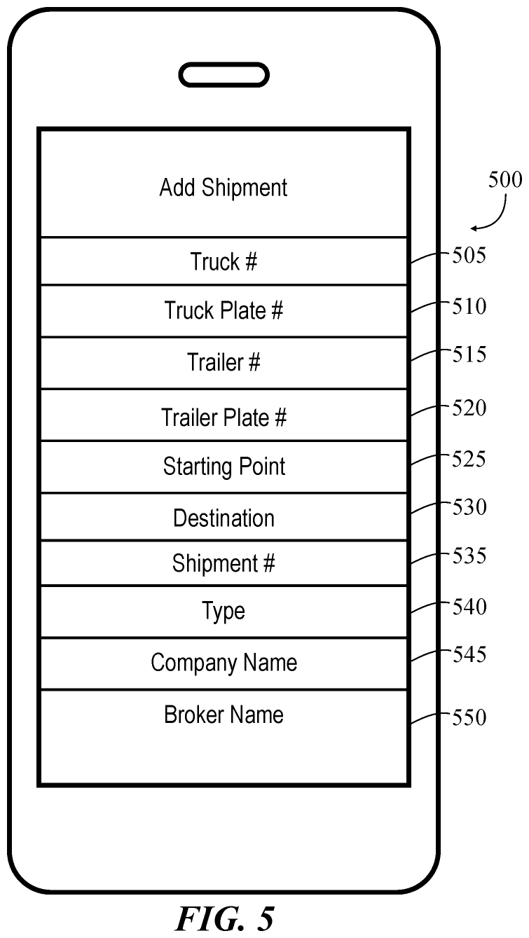

FIG. 5 illustrates the driver user interface 500 utilized by the driver to add a shipment to the system. The user (including the driver) can input data into a plurality of selection tabs including the truck number 505, truck plate number 510, trailer number 515, trailer plate number 520, starting point 525, destination 530, shipment number 535, type 540, company name 545, and the broker name 550. Each selection tab may permit the user to manually input data or to input data by selecting from a plurality of options on a drop-down menu.

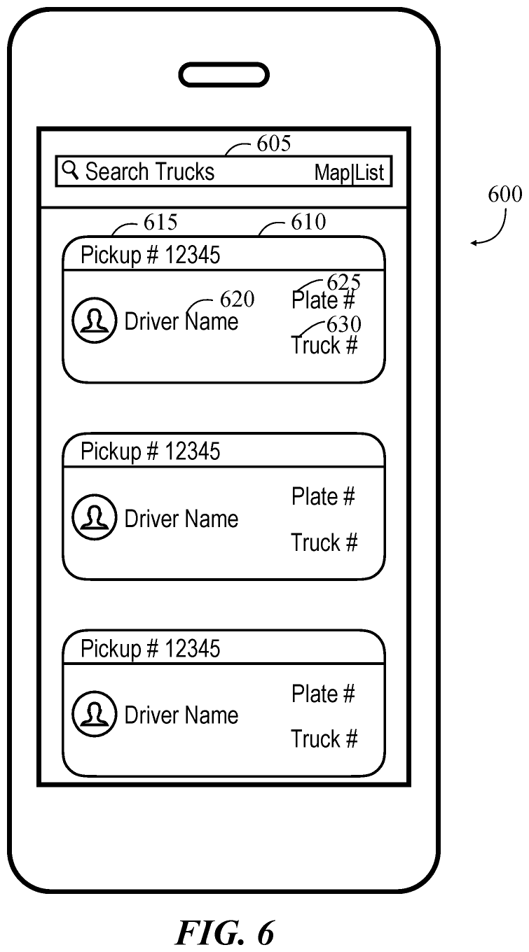

FIG. 6 illustrates the broker user interface 600 which includes a search function 605 to allow the broker to search from the database of drivers or other user types. A plurality of driver profiles 610 are provided and include the pickup number 615, driver name 620, plate number 625, and truck number 630. The broker may then select a driver profile 610 to view the driver's location, pick up information, and shipment progress.

In some embodiments, the broker interface allows for messaging to and from the driver, or other users of the system via a messaging system.

In some embodiments, the broker can add various data including a pick up number, MC number, DOT number, and other information related to the driver, the shipment details, the receiver, the destination, or likewise information.

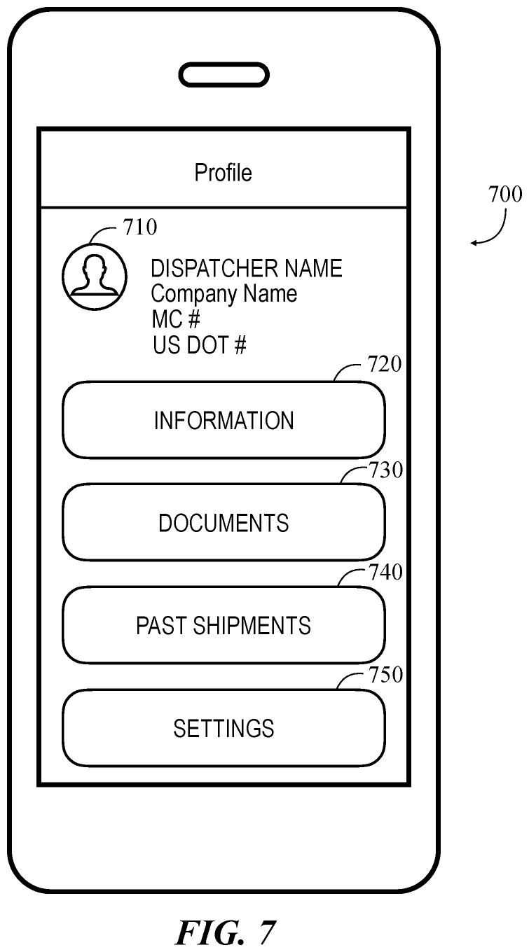

FIG. 7 illustrates the dispatcher interface 700, which includes the dispatcher profile 710. The dispatcher profile is comprised of the dispatcher name, company name, MC number, DOT number and other information known in the arts. The user may select from a plurality of tabs include an information tab 720 to view shipment information, documents tab 730 to view shipment related documents including bills of lading, past shipments tab 740 to view past shipment information, and settings tab 750 to view and modify user settings.

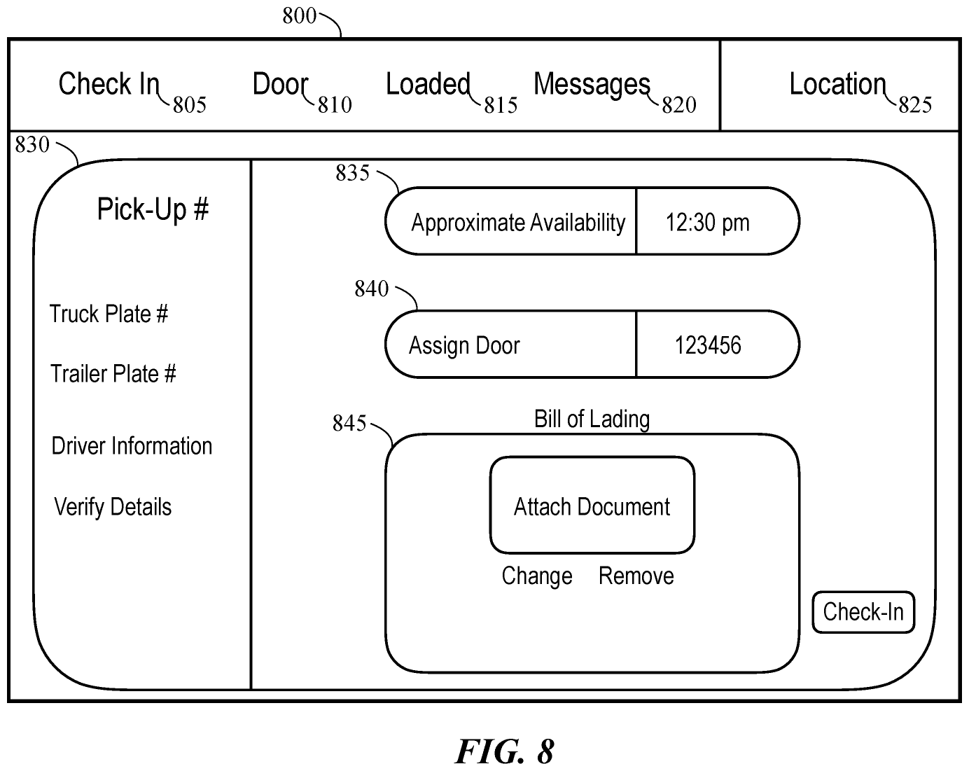

FIG. 8 illustrates the warehouse user interface 800 which can be utilized by the personnel in the warehouse to submit information related to each shipment and check-in a driver. A plurality of selectable tabs are provided which include a check in tab 805, a door tab 810, a loaded (or unloaded) tab 815, a messages tab 820 and a location tab 825. A pick-up interface 830 provides the user with various pick-up information for a particular shipment including the truck plate number, trailer plate number, driver information, and a verify details tab. The user is also provided with an approximate availability 835 for a particular location and/or driver and the option to assign a door 840 for the shipment. The user is also provided with a document upload interface 845 to allow the user to upload various documents, including the bill of lading.

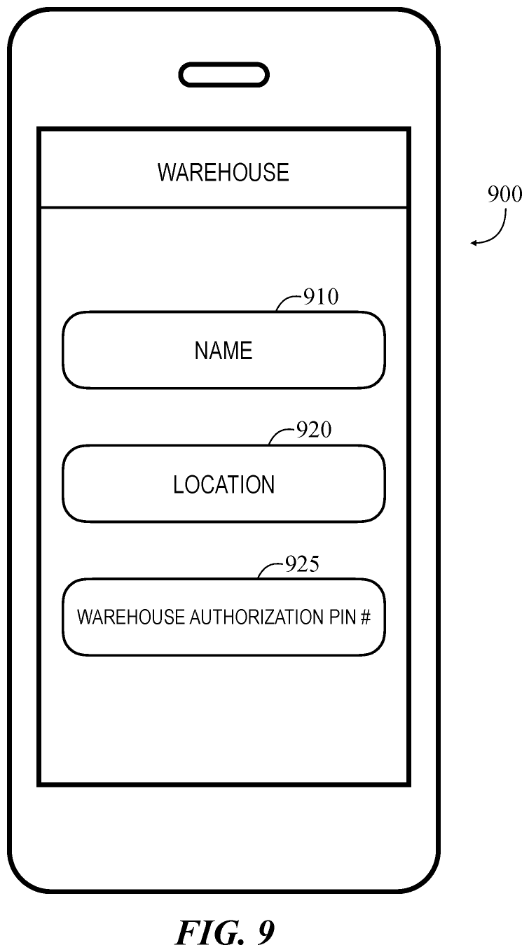

FIG. 9 illustrates the lumper profile interface 900 which allows the warehouse user to add a name 910, location 920, and warehouse authorization PIN number 925 for the warehouse. One skilled in the arts will readily understand that the warehouse profile interface may allow the user to submit a plurality of information related to the warehouse, warehouse personnel, or likewise data.

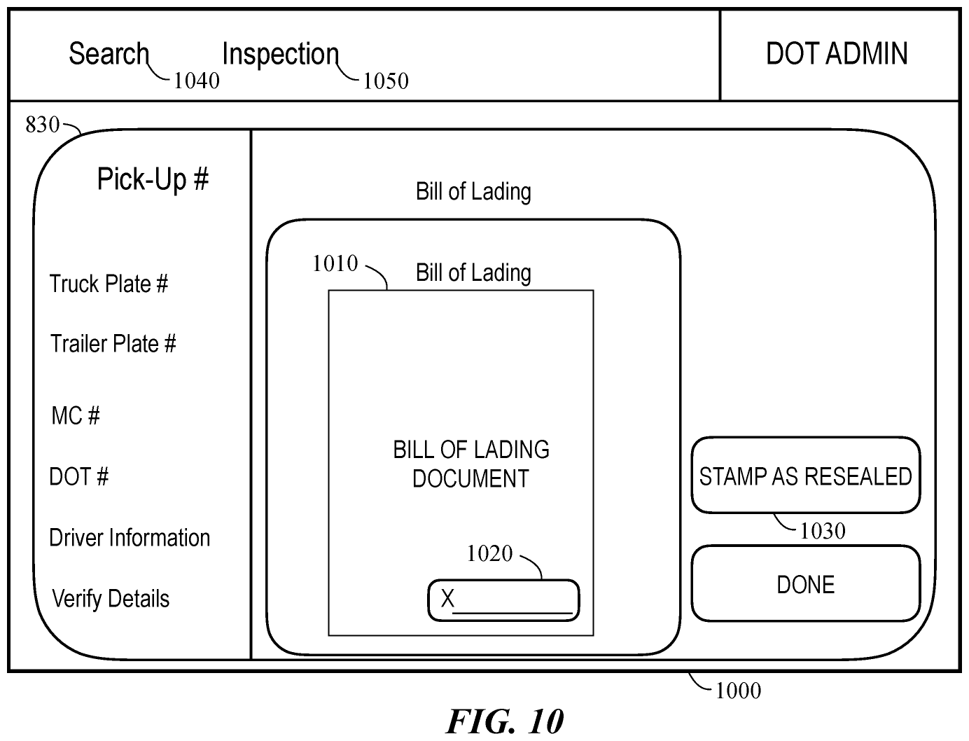

FIG. 10, illustrates the DOT user interface 1000, which is comprised of the pick-up interface 830 shown in FIG. 8. The pick-up interface 830 also includes various user information including an MC number, and DOT number. The bill of lading document 1010 is viewable by the user who may also sign or otherwise authenticate the bill of lading document 1010 using an authentication interface 1020. The user is provided with a stamp as resealed function 1030 which inputs a digital stamp onto the bill of lading document 1010. The DOT user is also provided with a search tab 1040 and an inspection tab 1050.

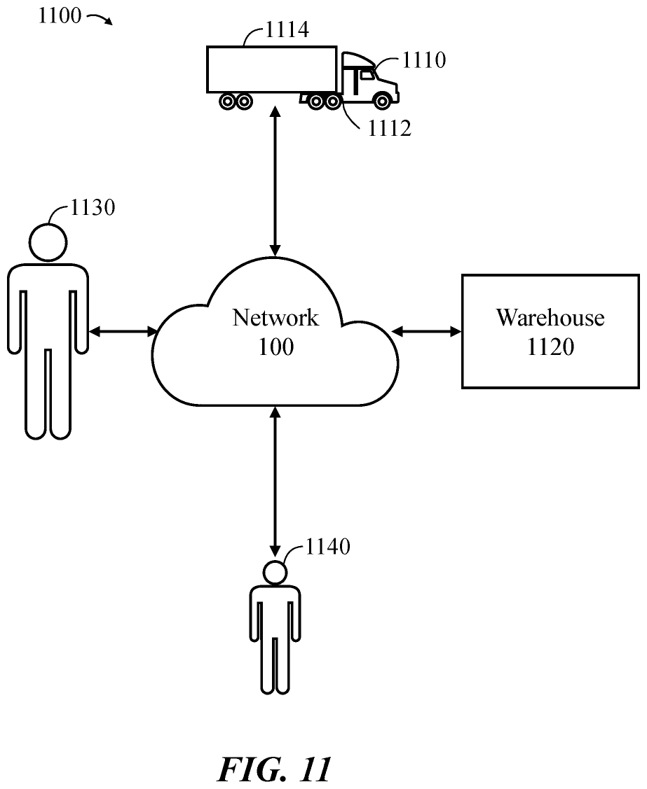

FIG. 11 illustrates a user-network configuration 1100 which is comprised of a plurality of drivers 1110, a warehouse 1120, a plurality of brokers 1130, and a plurality of lumpers 1140 each in communication with the system described hereinabove via the network 100. In some embodiments, administrative users may have access to various user interfaces, user information, and other functionalities described hereinabove. Each driver 1110 is associated with a vehicle 1112 and a vehicle trailer 1114. The vehicle includes a vehicle number and vehicle plate number associated with the vehicle. The warehouse 1120 may include a location and a plurality of doors which are used by the driver 1110 to ensure the driver arrives at a correct location at the warehouse for each shipment.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for monitoring shipping processes and personnel, the system comprising:
a plurality of vehicles each associated with a driver, the driver accessing an application to request and store data for one or more shipments;
a plurality of warehouses in communication with the application to request shipment of a plurality of goods, the shipment request transmitted to the plurality of drivers;
a database to store a plurality of data including driver information, warehouse information, and information for the one or more shipments; and
a camera in operable communication with the computing device, the camera operable to collect a plurality of images and transmit the plurality of images to a processor, the processor configured to interpret the plurality of images via an interpreter and input the information to a document, the document stored in a database and transmitted via the computing device to a second computing device operated by an administrative user.

2. The system of claim 1, wherein the data includes the following: load information, shipping information, a bill of lading, driver information, vehicle information, and trailer information.

3. The system of claim 1, wherein the computing device is in operable communication with an application server in operable communication with a plurality of modules including a scanning and imaging module, an interpreter, a scheduler, a logistics module, a comparator, and a communications module.

4. The system of claim 3, wherein the application server is in operable communication with a processor configured to perform the following:
receiving, via the camera, an image and scanning the image;
transmitting the scanned image to the interpreter;
interpreting the image for information contained therein; and
parsing the information into input fields in a document.

5. The system of claim 3, wherein the scheduler is configured to facilitate the efficient scheduling of the driver.

6. The system of claim 1, further comprising auxiliary personnel in communication with a scheduler.

7. The system of claim 4, wherein the auxiliary personnel include a plurality of lumpers, wherein the plurality of lumpers are scheduled via the scheduler to unload freight.

8. A system for monitoring shipping processes and personnel, the system comprising:
a plurality of vehicles each associated with a driver, the driver accessing an application to request and store data for one or more shipments;
a plurality of warehouses in communication with the application to request shipment comprising a plurality of shipment information, the shipment request transmitted to the plurality of drivers, wherein the shipment information is comprised of a truck number, a truck plate number, a trailer number, a trailer plate number, a starting point, a destination, a shipment number, a type, a company name, and a broker name;
a database to store a plurality of data including driver information, warehouse information, and information for the one or more shipments; and
a camera in operable communication with the computing device, the camera operable to collect a plurality of images and transmit the plurality of images to a processor, the processor configured to interpret the plurality of images via an interpreter and input the information to a document, the document stored in a database and transmitted via the computing device to a second computing device operated by an administrative user.

9. The system of claim 8, further comprising a department of transportation (DOT) user interface comprising a bill of lading document.

10. The system of claim 9, wherein the bill of lading document includes an authentication interface.

11. The system of claim 8, wherein the data includes the following: load information, shipping information, a bill of lading, driver information, vehicle information, and trailer information.

12. The system of claim 8, wherein the computing device is in operable communication with an application server in operable communication with a plurality of modules including a scanning and imaging module, an interpreter, a scheduler, a logistics module, a comparator, and a communications module.

13. The system of claim 12, wherein the application server is in operable communication with a processor configured to perform the following:
receiving, via the camera, an image and scanning the image;
transmitting the scanned image to the interpreter;
interpreting the image for information contained therein; and
parsing the information into input fields in a document.

14. The system of claim 13, wherein the scheduler is configured to facilitate the efficient scheduling of the driver.

15. The system of claim 8, further comprising auxiliary personnel in communication with a scheduler.

16. The system of claim 15, wherein the auxiliary personnel include a plurality of lumpers, wherein the plurality of lumpers are scheduled via the scheduler to unload freight.

17. A method for monitoring shipping processes and personnel, the method comprising the steps of:
creating, via a driver, a shipment comprising a plurality of shipment information;
accessing, via the driver and a warehouse, the plurality of shipment information;
checking in, via a driver, and assigning, via the warehouse a location and a wait time to the driver;
uploading, via the warehouse, a bill of lading to permit the driver to authenticate the bill of lading;
accessing, via a lumper, the shipment information and uploads a piece count and a receipt; and
authenticating, via the warehouse, the bill of lading with a proof of delivery.

18. The method of claim 17, wherein the plurality of shipment information includes the following: load information, shipping information, a bill of lading, driver information, vehicle information, and trailer information.

19. The method of claim 17, wherein a computing device is in operable communication with an application server in operable communication with a plurality of modules including a scanning and imaging module, an interpreter, a scheduler, a logistics module, a comparator, and a communications module.

20. The system of claim 19, wherein the application server is in operable communication with a processor configured to perform the following:
receiving, via the camera, an image and scanning the image;
transmitting the scanned image to the interpreter;
interpreting the image for information contained therein; and
parsing the information into input fields in a document.
